(19) United States
(12) Patent Application Publication
(10) Pub. No.: US 2011/0115581 A1
(43) Pub. Date: May 19, 2011

(54) APPARATUS AND METHOD FOR IMPLEMENTING LEFT-HANDED TRANSMISSION LINE

(75) Inventors: Jae-Ick CHOI, Daejeon (KR); Wangjoo Lee, Daejeon (KR); Jeong-Hae Lee, Seoul (KR); Young-Ho Ryu, Gyeongbuk (KR); Dong-Jin Kim, Seoul (KR); Jae-Hyun Park, Gyeonggi-do (KR)

(73) Assignee: ELECTRONICS AND TELECOMMUNICATIONS RESEARCH INSTITUTE, Daejon (KR)

(21) Appl. No.: 12/780,623

(22) Filed: May 14, 2010

(30) Foreign Application Priority Data
Nov. 13, 2009 (KR) 10-2009-0109958

(51) Int. Cl. H01P 3/08; C23F 1/00

(52) U.S. Cl. 333/246; 216/13

(57) ABSTRACT

An apparatus for implementing a left-handed transmission line includes: a substrate coated with a conductor and having a rectangular shape with a predefined size; a plurality of concave-convex lines disposed on a bottom surface of the substrate; two conductive vias disposed on a top surface of the substrate; a first bonding wire connecting top portions of a conductive line between the concave-convex lines connected between the first etching surface and the second etching surface; and a second bonding wire connecting bottom portions of a conductive line between the concave-convex lines connected between the first etching surface and the second etching surface.

### CROSS-REFERENCE(S) TO RELATED APPLICATIONS

The present application claims priority of Korean Patent Application No. 10-2009-0109958, filed on Nov. 13, 2009, which is incorporated herein by reference in its entirety.

### BACKGROUND OF THE INVENTION

1. Field of the Invention

Exemplary embodiments of the present invention relate to an apparatus and method for implementing a left-handed transmission line; and, more particularly, to an apparatus and method for implementing a left-handed transmission line which has a pure negative permittivity and a pure negative permeability.

2. Description of Related Art

In the natural phenomenon, materials around our surroundings have inherent permittivity and permeability. All materials such as glass and water have positive permittivity and permeability. Meta-materials refer to materials produced to have permittivity and permeability which do not exist in the nature through artificial processing. A material simultaneously having negative permittivity and permeability was theoretically identified in 1968, and a material having negative permittivity and permeability was actually implemented by using a periodic structure. In particular, a material simultaneously having negative permittivity and permeability is referred to as a left-handed material (LHM) because an electric field, a magnetic field, and a Poynting's vector of an electromagnetic wave follow a left-handed law unlike a general medium. The electromagnetic wave in LHM has characteristics such as a backward wave, a negative phase velocity, a reverse Snell's law, and a reverse Doppler effect, which are opposite to those of the existing electromagnetic wave. Using these new characteristics, various kinds of LHM have been implemented by many scientists and applied in many RF devices. In particular, since a 1-D LHM transmission line is easy to implement and analyze and also has a wide LH band, it has been widely applied in many applications.

FIGS. 1A to 1C illustrate equivalent models of transmission lines based on a general material and a meta-material. Specifically, FIG. 1A illustrates an equivalent model of a right-handed (RH) transmission line based on a general medium. All existing transmission lines have the equivalent model illustrated in FIG. 1A. In the case of the RH transmission line, a capacitance C_{R} is connected in parallel to an inductance L_{R}. FIG. 1B illustrates an equivalent model of a pure left-handed (LH) transmission line. In the case of the pure LH transmission line, an inductance L_{L} is connected in parallel to a capacitance C_{L}. However, it is actually impossible to manufacture the transmission line of FIG. 1B in the natural phenomenon. FIG. 1C illustrates an equivalent model of a composite right/left-handed (CRLH) transmission line. Since it is impossible to manufacture the LH transmission line in the natural phenomenon as described above, the transmission line is manufactured by adding a serial-type capacitance C_{L} and a branched-type inductance L_{L} to the existing transmission line of FIG. 1A. Such a transmission line is referred to as a CRLH transmission line because it has an LH characteristic at a low frequency and has an RH characteristic at a high frequency. The existing meta-material transmission line is the CRLH transmission line. In the CRLH transmission line, the equivalent permeability (μ_{eff}) and permittivity (∈_{eff}) may be expressed as Equation 1 below:

μ_{eff}=Z_{T}(ω)/jω and ∈_{eff}=Y_{T}(ω)/jω Eq. 1

where Z_{T} represents impedance, ω is ω=2πf and represents a frequency component, Y_{T} represents admittance, and j represents an imaginary component.

The existing meta-material transmission line has an LH transmission band (in which the permeability and the permittivity are simultaneously negative) at a low frequency and has an RH transmission band (in which the permeability and the permittivity are simultaneously positive) at a high frequency, depending on signs of the permeability and the permittivity. Therefore, the upper limit frequency of the LH transmission band occurring at the low frequency is affected, and the upper limit of the LH transmission band region is reduced. In addition, since the respective transmission band regions depend on all components of the equivalent circuit, that is, the inductance components and the capacitance components, there are limitations on applying to applications using the LH transmission band.

### SUMMARY OF THE INVENTION

An embodiment of the present invention is directed to an apparatus and method for implementing an LH transmission line having a wide bandwidth.

Another embodiment of the present invention is directed to an apparatus and method for easily implementing an LH transmission line.

Another embodiment of the present invention is directed to an apparatus and method for implementing an LH transmission line, which are capable of reducing hardware complexity.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for implementing a left-handed transmission line includes: a substrate coated with a conductor and having a rectangular shape with a predefined size; a plurality of concave-convex lines disposed on a bottom surface of the substrate, wherein the concave-convex lines have a first etching surface and a second edged surface meeting a predefined inductance value, being spaced apart by a predefined distance, and having a predefined shape, and the concave-convex lines meet a predefined capacitance value between the first etching surface and the second etching surface and are arranged so that the first etching surface and the second etching surface are connected together; two conductive vias disposed on a top surface of the substrate, wherein the vias are wider than the etched lines and have an identical direction so as to cover at least one etched concave-convex line among the etched lines disposed on the bottom of the substrate, have a predefined resistance value, both ends thereof are etched to have only a signal line having a first port and a second port, at least one line among the etched concave-convex lines is alternately arranged so that the vias pass through the top and bottom surfaces of the substrate; a first bonding wire connecting top portions of a conductive line between the concave-convex lines connected between the first etching surface and the second etching surface; and a second bonding wire connecting bottom portions of a conductive line between the concave-convex lines connected between the first etching surface and the second etching surface.

### BRIEF DESCRIPTION OF THE DRAWINGS

FIGS. 1A to 1C illustrate equivalent models of transmission lines based on a general material and a meta-material.

FIGS. 2A to 2C illustrate equivalent circuits for obtaining equivalently negative admittance (Y) value in order to implement an LH transmission line in accordance with an embodiment of the present invention.

FIG. 3 illustrates a unit cell structure of a pure left-handed (PLH) transmission line in accordance with an embodiment of the present invention.

FIGS. 4A to 4C illustrate equivalent circuits of PLH transmission lines of FIG. 3 in accordance with an embodiment of the present invention.

FIGS. 5A and 5B are result graphs showing equivalent permittivity and equivalent permeability in accordance with an embodiment of the present invention.

FIG. 6 illustrates a unit cell structure of a PLH transmission line having a wide LH transmission band in accordance with another embodiment of the present invention.

FIG. 7 is a characteristic graph showing dispersion characteristics of PLH transmission lines.

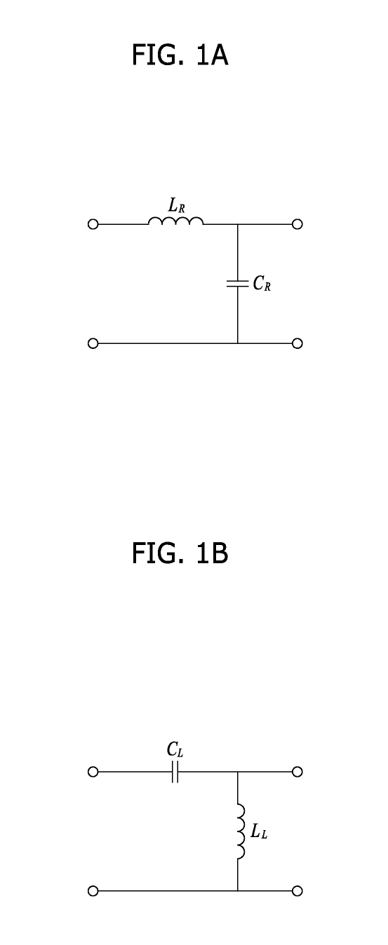

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In accordance with embodiments of the present invention, a pure left-handed (PLH) transmission line having only a pure LH transmission band is implemented by using only a distributed structure. Since the PLH transmission line cannot be implemented by using typical methods, a negative admittance value is obtained up to an infinite frequency by using a cross circuit having an equivalently negative element value, and a negative permittivity value is obtained up to an infinite frequency by Equation 1. Hence, a PLH transmission line having a wide LH transmission band can be implemented by making only an equivalent permeability value have a negative value in a wide range. Therefore, the upper limit of the LH band of the existing CRLH transmission line can be removed, and the LH characteristic can be applied in a wide range.

Hereinafter, embodiments of the present invention will be described in detail with reference the accompanying drawings.

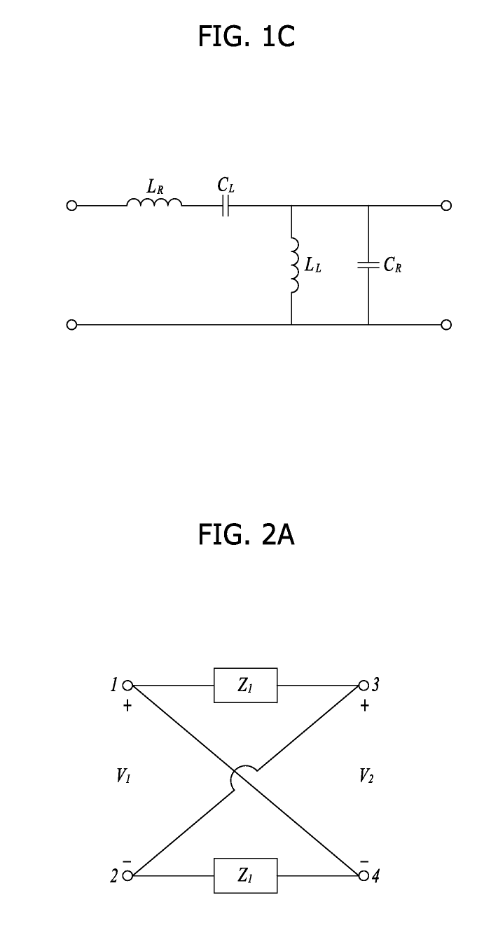

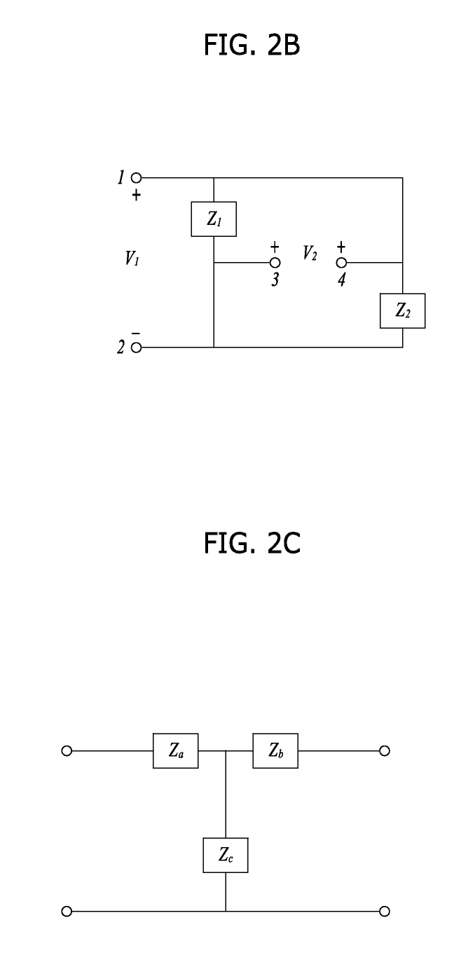

FIGS. 2A to 2C illustrate equivalent circuits which obtain an equivalently negative admittance (Y) value in order to implement an LH transmission line in accordance with an embodiment of the present invention.

FIG. 2A illustrates a cross circuit including a 4(1, 2, 3, 4)-terminal network in order to obtain an equivalently negative admittance value. The first terminal 1 is connected to the fourth terminal 4 and also connected to the third terminal 3. In this case, an impedance Z₁ exists between the first terminal 1 and the third terminal 3. The second terminal 2 is connected to the third terminal 3 and also connected to the fourth terminal 4. In this case, an impedance Z₂ exists between the second terminal 2 and the fourth terminal 4. The connection between the second terminal 2 and the fourth terminal 4 and the connection between the second terminal 2 and the third terminal 3 are crossed together in a space, and there is no contact point.

Regarding the voltage configuration, a voltage V₁ is applied between the first terminal 1 and the second terminal 2. Specifically, a positive (+) voltage is applied to the first terminal 1, and a negative (−) voltage is applied to the second terminal 2. In addition, a voltage V₂ is applied between the third terminal 3 and the fourth terminal 4. Specifically, a positive (+) voltage is applied to the third terminal 3, and a negative (−) voltage is applied to the fourth terminal 4.

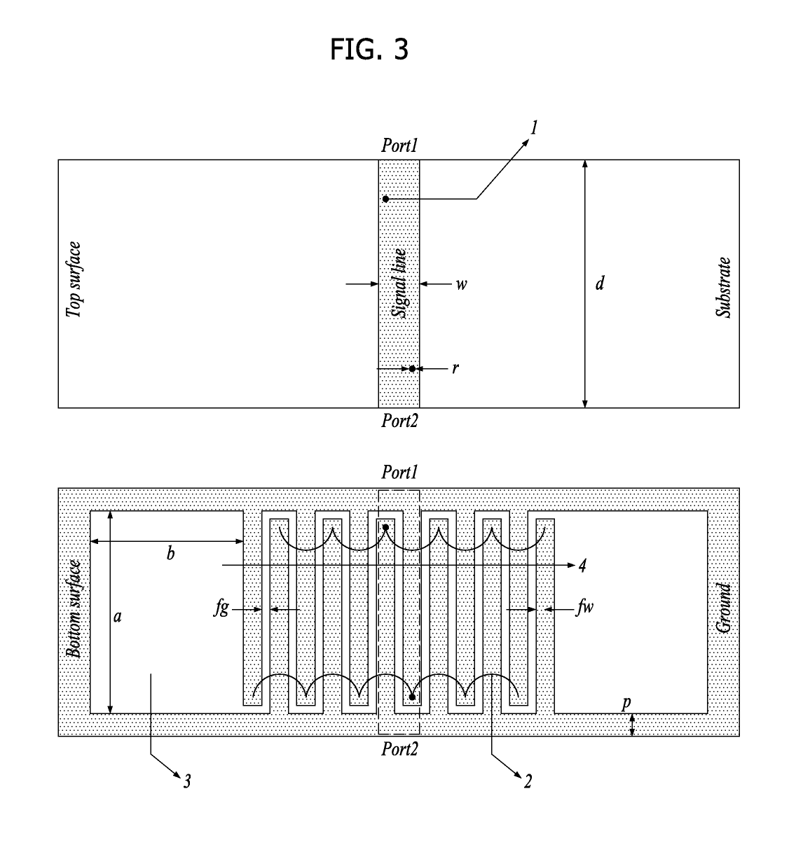

FIG. 2B illustrates a ladder circuit which is transformed from the cross circuit of FIG. 2A through a node analysis. In FIGS. 2A and 2B, a resistance parameter (r-parameter) is expressed as Equation 2 below. The first terminal 1 and the second terminal 2 of FIGS. 2A and 2B correspond to a first port 1 Port1 of FIG. 3, which will be described later, and the third terminal 3 and the fourth terminal 4 of FIGS. 2A and 2B correspond to a second port Port2 of FIG. 3, which will be described later. That is, the first terminal 1 refers to a signal of the first port Port1, and the second terminal 2 refers to a ground of the first port Port1. In addition, the third terminal refers to a signal of the second port Port2, and the fourth terminal refers to a ground of the second port Port2.

$${r}_{11} = \frac{{V}_{1}}{{I}_{1}} with {I}_{2} = 0 ⇒ \frac{{Z}_{1} {Z}_{2}}{{Z}_{1} + {Z}_{2}} \\ {r}_{12} = \frac{{V}_{1}}{{I}_{2}} with {I}_{1} = 0 ⇒ \frac{{Z}_{1} {Z}_{2}}{{Z}_{1} + {Z}_{2}} \\ {r}_{22} = \frac{{V}_{2}}{{I}_{2}} with {I}_{1} = 0 ⇒ \frac{{Z}_{1} {Z}_{2}}{{Z}_{1} + {Z}_{2}} \qquad Eq . 2$$

where r₁₁ is an r-parameter which is determined by a current I₁ and a voltage V₁ inputted to the port 1 Port1 when no current I₂ flows through the port 2 Port2 of FIG. 3,

r₁₂ is an r-parameter which is determined by a current I₂ and a voltage V₁ inputted to the port 2 Port2 when no current I₁ flows through the port 1 Port1 of FIG. 3, and

r₂₂ is an r-parameter which is determined by a current I₂ and a voltage V₂ inputted to the port 2 Port2 when no current I₁ flows through the port 1 Port1 of FIG. 3,

FIG. 2C illustrates an equivalent circuit which has a common ground through an r-parameter analysis. The impedance values of the equivalent circuit having the common ground may be expressed as Equation 3 below.

$$\begin{matrix}{Z}_{a} = {r}_{11} - {r}_{12} \\ = \frac{{Z}_{1} {Z}_{2}}{{Z}_{1} + {Z}_{2}} - ( - \frac{{Z}_{1} {Z}_{2}}{{Z}_{1} + {Z}_{2}} ) \\ = 2 \times \frac{{Z}_{1} {Z}_{2}}{{Z}_{1} + {Z}_{2}}\end{matrix} \\ \begin{matrix}{Z}_{b} = {r}_{21} - {r}_{12} \\ = \frac{{Z}_{1} {Z}_{2}}{{Z}_{1} + {Z}_{2}} - ( - \frac{{Z}_{1} {Z}_{2}}{{Z}_{1} + {Z}_{2}} ) \\ = 2 \times \frac{{Z}_{1} {Z}_{2}}{{Z}_{1} + {Z}_{2}}\end{matrix} \\ {Z}_{c} = {r}_{12} = - \frac{{Z}_{1} {Z}_{2}}{{Z}_{1} + {Z}_{2}} \qquad Eq . 3$$

In FIG. 2C, Zₐ and Z_{b} are serially-connected impedance values and an admittance value may be calculated by a parallel-connected impedance Z_{c}. Hence, using Equation 3 above, the admittance (Y) value of the equivalent circuit may be expressed as Equation 4. The admittance (Y) value of the equivalent circuit is negative and serves to make the permeability of Equation 1 negative.

$$Y = \frac{1}{{Z}_{c}} = \frac{1}{- \frac{{Z}_{1} {Z}_{2}}{{Z}_{1} + {Z}_{2}}} = - \frac{{Z}_{1} + {Z}_{2}}{{Z}_{1} {Z}_{2}} \qquad Eq . 4$$

FIG. 3 illustrates a unit cell structure of a PLH transmission line in accordance with an embodiment of the present invention.

Referring to FIG. 3, two ports Port1 and Port 2 for a signal input and a ground exist in order to implement a PLH transmission line. On the top surface of substrate, conductive vias 1 are provided symmetrically with respect to the center between signal lines having a constant length and width. On the bottom surface of the substrate, a defected ground structure (DGS) 3, a bonding wire 2, and an inter-digital capacitor (IDC) 4 are provided. The DGS 3 is formed by etching a substrate including conductive vias and a metal material in correspondence with the top surface. The bonding wire 2 serves to bond the regions which are constantly repeated in a structure obtained by etching a dielectric, that is, the alternately etched regions. The IDC 4 has a structure in which a metal material and an empty space are periodically provided.

As illustrated in FIG. 3, the unit cell in accordance with the embodiment of the present invention constitutes a ground plane with the DSG 3 having the IDC form and implements a cross circuit through the vias. The DSG structure is a structure in which a metal ground plane is etched. Since the DSG structure obstructs the dispersion of a current flowing the ground plane, an effective impedance of the transmission line is increased to thereby generate a stop band in a specific frequency band. Using this characteristic, a capacitance and an inductance of the transmission line are changed and thus characteristics of the transmission line are changed. In this case, only when the positions of the vias are implemented in a crossed form as illustrated in FIG. 3, the signal applied to the port 1 Port1 is transferred to the signal line through the via, and a current simultaneously flows to the ground plane connected to the second port Port2. In this manner, the cross circuit of FIG. 2A is implemented. In order to remove parasitic modes generated by the IDC having a multiple conductive structure and obtain a wide LH operation region, the top portion and the bottom portion of the IDC are wire-bonded. The top portion refers to an end portion in a direction of the port 1 Port1 of the conductive part which is not etched in a concave-convex shape, and the bottom portion refers to an end portion in a direction of the port 2 Port2 of the conductive part which is not etched in the concave-convex shape. The signal line in accordance with the embodiment of the present invention may be so wide that a general microstrip line has a resistance of 50Ω. To adjust the resistance of the microstrip line, the signal line may be implemented to be wider or narrower.

In the configuration of the transmission line of FIG. 3, the widths d of the top and bottom of the transmission line substrate are 5.2 mm. The signal line exists in the center of the top of the substrate and has a width w of 1.1 mm. The signal line includes one or more unetched concave-convex lines. The term “includes” means that one or more concave-convex lines can cover the signal line, when viewed from above the substrate. In addition, two ports Port1 and Port2 receiving signals are provided on both edges of the signal line, that is, on both ends of the signal line. The vias receiving the signals through the ports are provided symmetrically with respect to the center of the signal line.

The bottom surface of the transmission line is etched in order to implement the PLH transmission line in the substrate covered with the metal. The edges of the substrate is etched in a shape of a 5 mm×5 mm square left and right, with a predetermined space defined therebetween. The gap between the squares is etched in a concave-convex shape. Although the square shape has been exemplified as the etched structure in the above-described embodiment, the etched structure may also be implemented in a general shape, for example, a polygonal shape and a circular shape, depending on the implementation shape. In addition, the concave-convex shape may be divided into a region where the metal exists and a region where no metal exists. Furthermore, the etched structure may also be implemented in a rectangular sawtooth shape so that a gap (fg=0.1 mm) is formed in order to connect the etched portions. That is, the substrate is etched so that the metal material alternately exists in a downward direction (from the port 1 Port1 to the port 2 Port2) and an upward direction (from the port 2 Port2 to the port 1 Port 1). A pair of conductors in the downward direction and the upward direction is defined as a finer pair. In this embodiment, six fingers are provided. The group of the fingers may be configured with six fingers (where n is a natural number equal to or greater than 1). The width fw of the concave-convex metal is 0.5 mm.

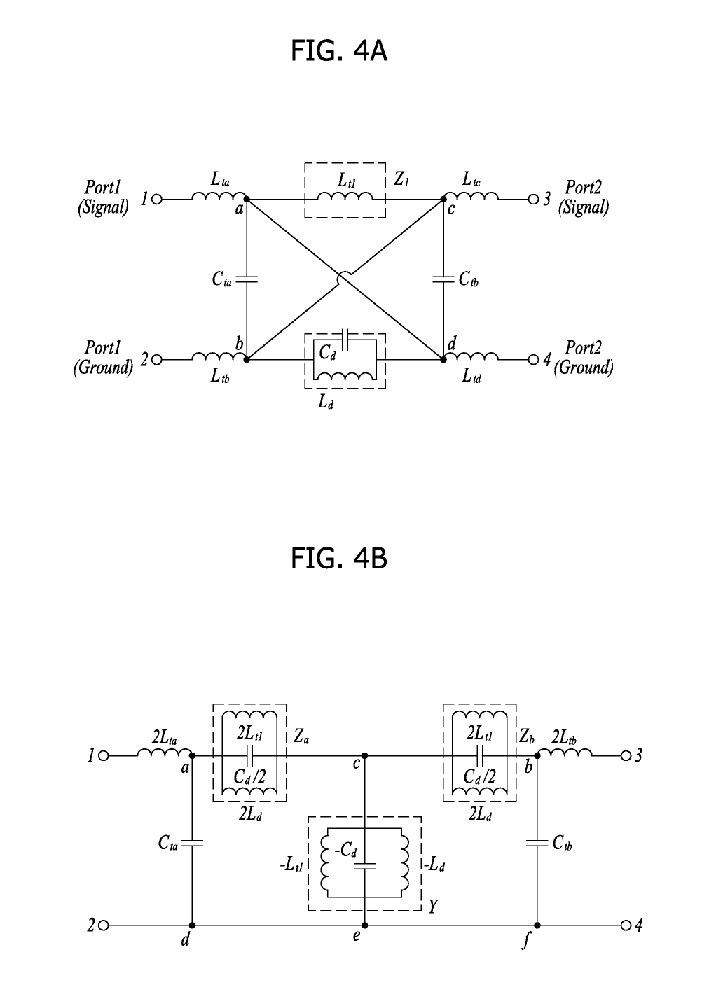

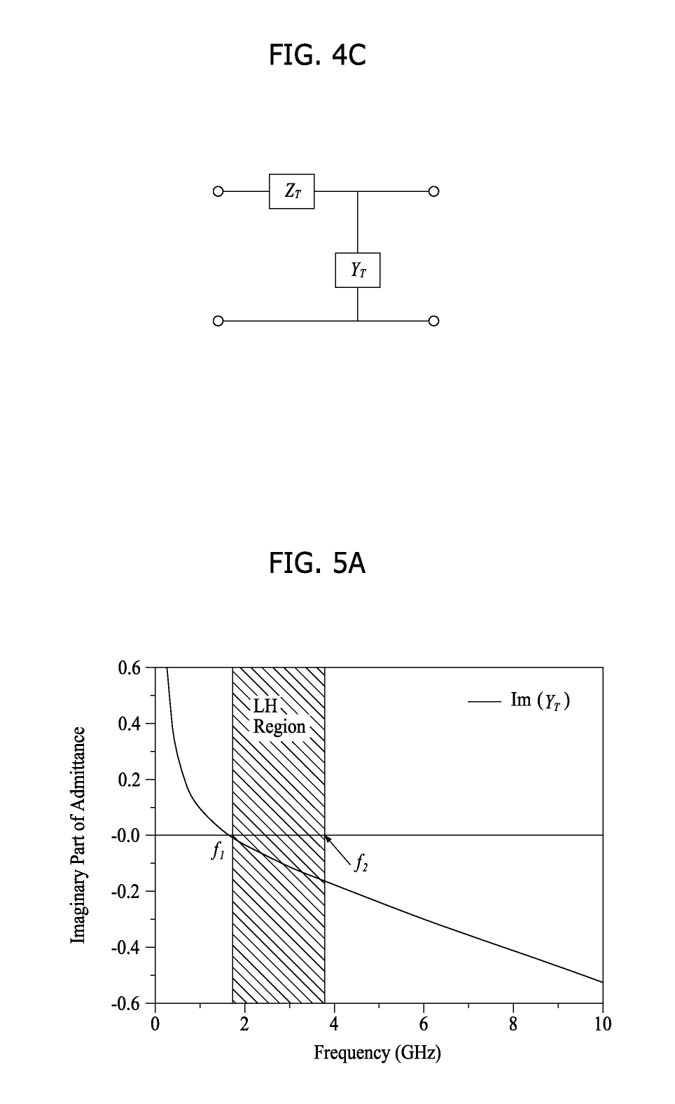

FIGS. 4A to 4C illustrate equivalent circuits of the PLH transmission line implemented in FIG. 3 in accordance with the embodiment of the present invention.

In FIG. 4A, it is assumed that a contact point between an inductance Lₜₐ and a first impedance Z₁ is defined as “a”, and a contact point between the first impedance Z₁ and an inductance L_{tc} is defined as “c”. In addition, it is assumed that a contact point between an inductance L_{tb} and a second impedance Z₂ is defined as “b”, and a contact point between the second impedance Z₂ and an inductance L_{td} is defined as “d”.

In the configuration of FIG. 4A, the inductance Lₜₐ, the first impedance Z₁, and the inductance L_{tc} are connected in series between a first terminal 1 Port1 (Signal) and a third terminal 3 Port2 (Signal). In addition, the inductance L_{tb}, the second impedance Z₂, and the inductance L_{td} are connected in series between a second terminal 2 Port1 (Ground) and a fourth terminal 4 Port2 (Ground). A capacitance Cₜₐ is connected between the contact point a and the contact point b, and a capacitance C_{tb} is connected between the contact point c and the contact point d. Furthermore, in order to implement the cross circuit, the contact point a and the contact point d are connected together, and the contact point b and the contact d are connected together. In FIG. 4A, the first impedance Z₁ is configured by an impedance Lₜ₁, and the second impedance Z₂ is configured by the parallel connection of a capacitance component C_{d} and an inductance component L_{d} of the DGS. Generally, the DGS is a parallel resonance circuit and may be expressed by C_{d} and L_{d} in FIG. 4A.

Also, the inductances Lₜₐ, L_{tb}, L_{tc} and L_{td} are the same components, and the capacitances Cₜₐ and C_{tb} are the same components. In addition, Lₜₐ, L_{tb}, L_{tc}/L_{td}, Lₜ₁, Cₜₐ, and C_{tb} are inherent components of the general microstrip and are parasitic components of the PLH transmission line. Lₜₐ, L_{tb}, L_{tc}, and L_{td} are inductance values between the port and the via and depend on the form of the transmission line between the port and the via. In addition, Lₜ₁ is an inductance value between the via and the via and depends on the form of the transmission line between the via and the via. The first impedance Z₁ and the second impedance Z₂ may be expressed as Equation 5 below.

$${Z}_{1} = jω {L}_{t 1} \\ {Z}_{2} = \frac{jω {L}_{d}}{1 - {ω}^{2} {C}_{d} {L}_{d}} \qquad Eq . 5$$

FIG. 4B illustrates an equivalent circuit of the PLH transmission line which is transformed from that of FIG. 4A by r-parameter.

Terminals 1, 2, 3 and 4 have the same meanings as the terminals 1, 2, 3 and 4 of FIG. 4A. In FIG. 4B, it is assumed that a contact point between a first inductance 2Lₜₐ and a first impedance Zₐ is defined as “a”, a contact point between the first impedance Zₐ and a second impedance Z_{b} is defined as “c”, a contact point between the second impedance Z_{b} and a second inductance 2L_{tb} is defined as “b”.

In the configuration of FIG. 4B, the first inductance 2Lₜₐ, the first impedance Zₐ, the second impedance Z_{b}, and the second inductance 2L_{tb} are connected in series between the first terminal 1 and the third terminal 3. In addition, a first capacitance Cₜₐ, an admittance Y, and a second capacitance C_{tb} are connected in parallel with respect to the contact points a, b and c, respectively. In this case, the respective inductance values are equal to each other, that is, Lₜₐ=L_{tb}. The respective capacitance values are also equal to each other, that is, Cₜₐ=C_{tb}. Furthermore, the first impedance value Z₁ and the second impedance value Z₂ are symmetrically equal to each other. Hence, by substituting the first impedance Z₁ and the second impedance Z₂ of Equation 5 into Equation 2, the resistance component by the r-parameter transformation of FIG. 4B may be expressed as Equation 6 below. The subscripts have the same meanings as in Equation 2 described above.

$$\begin{matrix}{r}_{11} = \frac{{Z}_{1} {Z}_{2}}{{Z}_{1} + {Z}_{2}} \\ = \frac{jω {L}_{t 1} \cdot \frac{jω {L}_{d}}{1 - {ω}^{2} {C}_{d} {L}_{d}}}{jω {L}_{t 1} + \frac{jω {L}_{d}}{1 - {ω}^{2} {C}_{d} {L}_{d}}} \\ = \frac{jω {L}_{t 1} \cdot jω {L}_{d}}{( 1 - {ω}^{2} {C}_{d} {L}_{d} ) \cdot jω {L}_{t 1} + jω {L}_{d}} \\ = \frac{- {ω}^{2} {L}_{t 1} {L}_{d}}{jω ( {L}_{t 1} + {L}_{d} - {ω}^{2} {C}_{d} {L}_{t 1} {L}_{d} )}\end{matrix} \\ \begin{matrix}{r}_{12} = - \frac{{Z}_{1} {Z}_{2}}{{Z}_{1} + {Z}_{2}} \\ = - \frac{jω {L}_{t 1} \cdot \frac{jω {L}_{d}}{1 - {ω}^{2} {C}_{d} {L}_{d}}}{jω {L}_{t 1} + \frac{jω {L}_{d}}{1 - {ω}^{2} {C}_{d} {L}_{d}}} \\ = - \frac{jω {L}_{t 1} \cdot jω {L}_{d}}{( 1 - {ω}^{2} {C}_{d} {L}_{d} ) \cdot jω {L}_{t 1} + jω {L}_{d}} \\ = - \frac{- {ω}^{2} {L}_{t 1} {L}_{d}}{jω ( {L}_{t 1} + {L}_{d} - {ω}^{2} {C}_{d} {L}_{t 1} {L}_{d} )} \\ = \frac{{ω}^{2} {L}_{t 1} {L}_{d}}{jω ( {L}_{t 1} + {L}_{d} - {ω}^{2} {C}_{d} {L}_{t 1} {L}_{d} )}\end{matrix} \\ \begin{matrix}{r}_{22} = \frac{{Z}_{1} {Z}_{2}}{{Z}_{1} + {Z}_{2}} \\ = \frac{jω {L}_{t 1} \cdot \frac{jω {L}_{d}}{1 - {ω}^{2} {C}_{d} {L}_{d}}}{jω {L}_{t 1} + \frac{jω {L}_{d}}{1 - {ω}^{2} {C}_{d} {L}_{d}}} \\ = \frac{jω {L}_{t 1} \cdot jω {L}_{d}}{( 1 - {ω}^{2} {C}_{d} {L}_{d} ) \cdot jω {L}_{t 1} + jω {L}_{d}} \\ = \frac{- {ω}^{2} {L}_{t 1} {L}_{d}}{jω ( {L}_{t 1} + {L}_{d} - {ω}^{2} {C}_{d} {L}_{t 1} {L}_{d} )}\end{matrix} \qquad Eq . 6$$

Substituting the resistance components calculated in Equation 6 into Equation 3 yields the impedance and admittance values expressed as Equation 7 below.

$$\begin{matrix}{Z}_{a} = 2 \times \frac{{Z}_{1} {Z}_{2}}{{Z}_{1} + {Z}_{2}} \\ = \frac{- 2 {ω}^{2} {L}_{t 1} {L}_{d}}{jω ( {L}_{t 1} + {L}_{d} - {ω}^{2} {C}_{d} {L}_{t 1} {L}_{d} )}\end{matrix} \\ \begin{matrix}{Z}_{b} = 2 \times \frac{{Z}_{1} {Z}_{2}}{{Z}_{1} + {Z}_{2}} \\ = \frac{- 2 {ω}^{2} {L}_{t 1} {L}_{d}}{jω ( {L}_{t 1} + {L}_{d} - {ω}^{2} {C}_{d} {L}_{t 1} {L}_{d} )}\end{matrix} \\ \begin{matrix}{Z}_{c} = - \frac{{Z}_{1} {Z}_{2}}{{Z}_{1} + {Z}_{2}} \\ = \frac{{ω}^{2} {L}_{t 1} {L}_{d}}{jω ( {L}_{t 1} + {L}_{d} - {ω}^{2} {C}_{d} {L}_{t 1} {L}_{d} )}\end{matrix} \\ \begin{matrix}Z = {Z}_{a} \\ = {Z}_{b} \\ = 2 \times \frac{{Z}_{1} {Z}_{2}}{{Z}_{1} + {Z}_{2}} \\ = \frac{- 2 {ω}^{2} {L}_{t 1} {L}_{d}}{jω ( {L}_{t 1} + {L}_{d} - {ω}^{2} {C}_{d} {L}_{t 1} {L}_{d} )}\end{matrix} \\ \begin{matrix}Y = \frac{1}{{Z}_{c}} \\ = \frac{{Z}_{1} + {Z}_{2}}{{Z}_{1} {Z}_{2}} \\ = \frac{jω ( {L}_{t 1} + {L}_{d} - {ω}^{2} {C}_{d} {L}_{t 1} {L}_{d} )}{{ω}^{2} {L}_{t 1} {L}_{d}}\end{matrix} \qquad Eq . 7$$

FIG. 4C illustrates the result of a successive T-π transformation of the configuration of FIG. 4B. The impedance Z_{T} and the admittance Y_{T} can be calculated using Equations 5 and 6, and an equivalent permittivity and an equivalent permeability can be calculated from Equation 1.

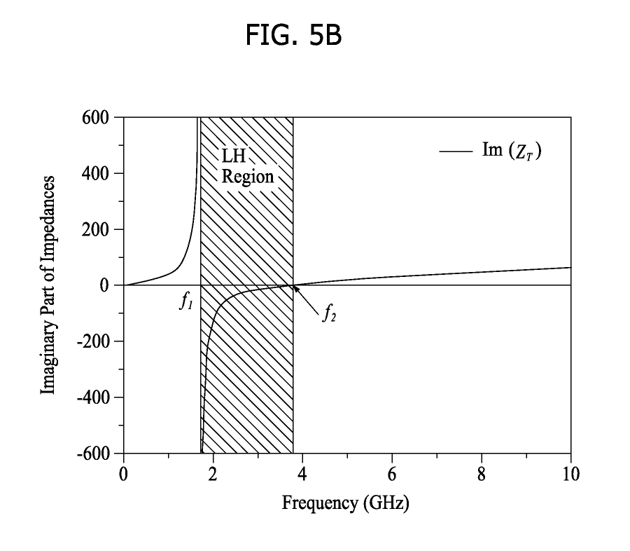

FIGS. 5A and 5B is a result graph showing an equivalent permittivity and an equivalent permeability in accordance with an embodiment of the present invention.

Specifically, FIG. 5A shows the equivalent permittivity based on the admittance, and FIG. 5B shows the equivalent permeability based on the impedance.

In FIG. 5A, the equivalent permittivity has a negative value after a cutoff frequency f₁ and continuously increases in proportion to the frequency. In FIG. 5B, the equivalent permeability has a negative value between a frequency f₁ and a frequency f₂. As shown in FIG. 5A, there is no RH transmission band because the permittivity continuously has a negative value after a frequency f₂. In addition, it can be seen that the frequencies f₁ and f₂ determining the LH band through the equivalent circuit parameter transformation depend on the inductances Lₜ and Lₜ₁ of the host transmission line. That is, the HL transmission band increases as the inductance L₁ is smaller and the inductance L₂ is larger.

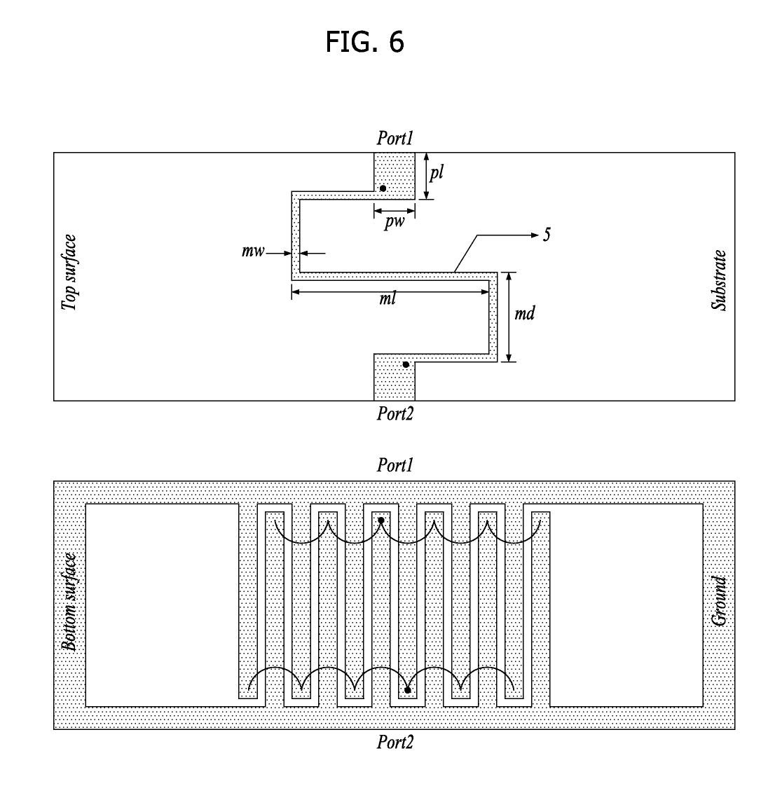

FIG. 6 illustrates a unit cell structure of a PLH transmission line having a wide LH transmission band in accordance with another embodiment of the present invention.

The PLH transmission line of FIG. 6 is a modified PLH transmission line having a wide LH transmission band through an equivalent parameter analysis. The transmission line is widened in order to reduce an inductance Lₜ which depends on a transmission line type between a port and a via, and a meander-type signal line is applied in order to increase an inductance Lₜ₁ which depends on a transmission line type between vias. The signal line of FIG. 6 has a meander line type, instead of a signal line having a constant width. The width pw of the signal line including the via is 2.3 mm, and a width mw of metal in the meander-type signal line is 0.2 mm. A left/right maximum length of the meander-type signal line is 5 mm. Also, the lower portion of the signal line including the via is bent in a “ [symbol] ” shape, and an end of the [symbol] -shaped signal line is bent in a reversed “ [symbol] ” shape. In this case, a vertical length and of the [symbol] shape is 2.1 mm.

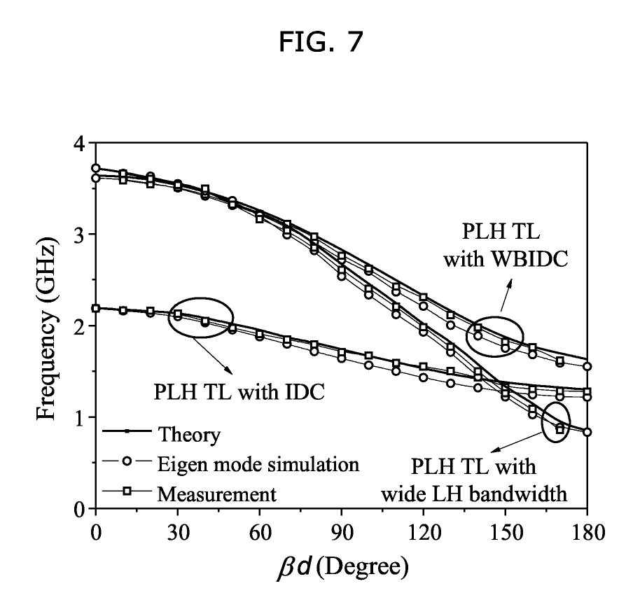

FIG. 7 is a characteristic graph showing dispersion characteristics of the PLH transmission lines. Specifically, FIG. 7 is a graph showing supportable frequency bandwidths of the PLH transmission lines, and shows results of the PLH transmission using IDC, the PLH transmission line using IDC having a bonding wire, and the PLH transmission line for implementing a wide LH band as illustrated in FIG. 6. The magnitude of the supportable frequency bandwidths increases the PLH transmission line for implementing a wide LH band as illustrated in FIG. 6, the PLH transmission line using IDC having a bonding wire, and the PLH transmission line using IDC. Moreover, in the case of the PLH transmission line using an IDC type DGS, an LH fractional transmission band is 67%. In the case of the transmission line where a bonding wire is applied to IDC, an LH fractional transmission band is 83%. In the case of the modified PLH transmission line, an LH transmission band is 140%. The apparatus and method for implementing the LH transmission line in accordance with the embodiments of the present invention can easily implement the LH transmission line having a wide bandwidth and can reduce hardware complexity.

While the present invention has been described with respect to the specific embodiments, it will be apparent to those skilled in the art that various changes and modifications may be made without departing from the spirit and scope of the invention as defined in the following claims.

What is claimed is:

1. An apparatus for implementing a left-handed transmission line, the apparatus comprising:
a substrate coated with a conductor and having a rectangular shape with a predefined size;
a plurality of concave-convex lines disposed on a bottom surface of the substrate, wherein the concave-convex lines have a first etching surface and a second edged surface meeting a predefined inductance value, being spaced apart by a predefined distance, and having a predefined shape, and the concave-convex lines meet a predefined capacitance value between the first etching surface and the second etching surface and are arranged so that the first etching surface and the second etching surface are connected together;
two conductive vias disposed on a top surface of the substrate, wherein the vias are wider than the etched lines and have an identical direction so as to cover at least one etched concave-convex line among the etched lines disposed on the bottom of the substrate, have a predefined resistance value, both ends thereof are etched to have only a signal line having a first port and a second port, at least one line among the etched concave-convex lines is alternately arranged so that the vias pass through the top and bottom surfaces of the substrate;
a first bonding wire connecting top portions of a conductive line between the concave-convex lines connected between the first etching surface and the second etching surface; and
a second bonding wire connecting bottom portions of a conductive line between the concave-convex lines connected between the first etching surface and the second etching surface.

2. The apparatus of claim 1, wherein the signal line is disposed at the center of the substrate.

3. The apparatus of claim 1, wherein the signal line has an identical width from the first port to the second port.

4. The apparatus of claim 1, wherein the signal line has concave-convex portions between the vias.

5. The apparatus of claim 4, wherein a width of the concave-convex portion is less than that of a signal line including the vias by a predefined multiple.

6. A method for implementing a left-handed transmission line, the method comprising:
coating a substrate with a conductor, the substrate having a rectangular shape with a predefined size;
etching two etching surfaces meeting a predefined inductance value, being spaced apart by a predefined distance, and having a predefined shape on a bottom of the substrate;
arranging a plurality of etched concave-convex lines meeting a predefined capacitance value between the two etching surfaces on the bottom of the substrate so that the two etching surfaces are connected together;
performing an etching process to form a signal line which is wider than the etched lines and has an identical direction so as to cover at least one etched concave-convex line among the etched lines disposed on the bottom of the substrate, and have a predefined resistance value;
configuring two conductive vias in which at least one line among the etched concave-convex lines is alternately arranged so that the vias pass through the top and bottom surfaces of the substrate;
installing ports at ends of the signal line to which is a signal is inputted through the two vias;
connecting top portions of a conductive line between the concave-convex lines; and
connecting bottoms of the conductive line between the concave-convex lines.

7. The method of claim 6, wherein the signal line is disposed at the center of the substrate.

8. The method of claim 6, wherein the signal line has an identical width from the first port to the second port.

9. The apparatus of claim 8, wherein a width of the concave-convex portion is less than that of a signal line including the vias by a predefined multiple.
